(19) United States
(12) Patent Application Publication
(10) Pub. No.: US 2019/0190441 A1
(43) Pub. Date: Jun. 20, 2019

(54) Dual Axis Solar Tracking System

(71) Applicant: Ravi Kumar Kannan, Houston, TX (US)

(72) Inventor: Ravi Kumar Kannan, Houston, TX (US)

(21) Appl. No.: 16/223,688

(22) Filed: Dec. 18, 2018

Related U.S. Application Data
(60) Provisional application No. 62/607,751, filed on Dec. 19, 2017.

(51) Int. Cl. H02S 20/32; F24S 30/455; F24S 50/80; F24S 80/58

(52) U.S. Cl. CPC H02S 20/32; F24S 30/455; F16H 19/04; F24S 80/58; F24S 50/80

(57) ABSTRACT

Solar tracking assemblies and methods for tracking the movement of the Sun are described herein. The dual axis solar tracking system generally includes a foundation, a primary layer, a secondary layer, and at least one motor that controls a first and second actuator. The foundation is designed to uniformly distribute the weight of the solar tracking assembly in the absence of additional securing or structural supports. The primary layer is adapted to rotate relative to a primary axis. The secondary layer is adapted to rotate relative to a secondary axis. The secondary layer is adapted for attachment of a payload thereto which may absorb the Sun's energy.

### CROSS-REFERENCE TO RELATED APPLICATIONS

This application claims the benefit of U.S. Provisional Patent Application Ser. No. 62/607,751, filed Dec. 19, 2017.

### FIELD

Embodiments generally relate to solar tracking assemblies and methods for tracking the movement of the sun.

### BACKGROUND

As reflected in the patent literature, a solar tracker is a device that orients a payload toward the Sun to collect direct sunlight for a longer period during the day and optimize the amount of solar energy collected. It is a useful tool to compensate for the reflective losses of a fixed solar panel, which can lose up to 75% of the Sun's energy in the morning and evening.

The Sun has a daily east-west motion and a yearly north-south motion. The daily east-west motion refers to the Sun's daily 360 degrees journey from east to west. From a fixed location on Earth's surface, this will consist of approximately 180 degrees of motion during an average half-day period. The yearly north-south motion of the Sun varies with the seasons of the year. The Earth's tilted axis means the Sun moves through 46 degrees north and south during the course of a year.

It is desirable to track both the north-south and east-west movement of the Sun to optimize the amount of solar energy that can be collected. Tracking the Sun's movements allows for energy collection for the longest period in a day. There is a significant amount of energy available during the early mornings and late afternoons that fixed solar panels do not collect. The use of a solar tracker can produce anywhere from 30-45% more energy than a fixed solar panel alone since the payload will always be oriented toward the Sun.

A solar tracker can typically be mounted into the ground, on a rooftop, or on a carport. The optimal type of solar tracker installation will vary depending on whether the solar collection is for a residential or commercial use and how much ground space or roof space is available.

A single axis tracker attempts to compensate for the reductive losses of fixed solar panels by tracking the east-west movement of the Sun. However, the single axis tracker fails to account for the north-south movement of the Sun. Thus, a dual axis solar tracker is desired to track both movements and collect the most amount of sunlight possible. A dual axis solar tracker accounts for both the daily and seasonal motions of the Sun and can produce anywhere from 30-45% more energy than a fixed system.

However, the applicability of dual axis trackers to a rooftop installation can be limited because they tend to be mounted on a center pole, thus creating a pointed load. This pointed load can damage a rooftop, ultimately harming a building's structure, and will often require expensive solutions such as additional securing and structural devices to allow for rooftop installation of a dual axis solar tracker. Even in the absence of a pointed load, roof solar trackers are required to be anchored into the roof and can further damage the building's structure.

Many commercial and residential users have shied away from the significant benefits of dual axis solar trackers to avoid damaging their rooftops. As a result, a majority of dual axis solar trackers in the field are not designed for rooftop installations.

Therefore, a need exists for an improved design that allows a user to receive the benefits of a dual axis solar tracker while avoiding damage to the installation surface. Further, there is a need for a dual axis solar tracker that is more cost-efficient and adaptable to a wider range of installation surfaces.

### SUMMARY

Solar tracking assemblies and methods for tracking the movement of the Sun are described herein. Embodiments generally include a foundation with a footing adapted to uniformly distribute the weight of the solar tracking assembly in the absence of additional securing or structural supports; a primary layer that is operably connected to the foundation, wherein the primary layer is adapted to rotate relative to a primary axis; a secondary layer operably connected to the primary layer and adapted for attachment of a payload thereto and coupled to the primary layer to allow the secondary layer to rotate relative to a secondary axis; and a motor electrically coupled to a first and second actuator to control movement of the primary and secondary layers.

One or more embodiments include the solar tracking assembly of the preceding paragraph, wherein the primary axis is adapted to track north-south variations of the sun and the secondary axis is adapted to track east-west variations of the sun.

One or more embodiments include the solar tracking assembly of any preceding paragraph of this section, wherein the primary axis is adapted to track east-west variations of the sun and the secondary axis is adapted to track north-south variations of the sun.

One or more embodiments include the solar tracking assembly of any preceding paragraph of this section, wherein the first actuator is at least one hydraulic jack that controls tilt adjustment along the primary axis.

One or more embodiments include the solar tracking assembly of the preceding paragraph, wherein the second actuator is a plurality of curved racks and pinion gears.

One or more embodiments include the solar tracking assembly of the preceding paragraph, wherein the plurality of curved racks and pinion gears are connected by at least one drive shaft electrically coupled to the motor. One or more embodiments include the solar tracking assembly of the preceding paragraph, wherein the second actuator is at least one shaft adapted to control rotation along the secondary axis.

One or more embodiments include the solar tracking assembly of the preceding paragraph, wherein the at least one shaft has a bevel gear operably coupled to a perpendicular shaft.

One or more embodiments include the solar tracking assembly of the preceding paragraph, wherein the perpendicular shaft is electrically coupled to the motor.

One or more embodiments include the solar tracking assembly of any preceding paragraph, including at least one solar module attached to the secondary layer.

One or more embodiments include the solar tracking assembly of the preceding paragraph, including from 16 to 18 solar modules.

Methods of tracking the sun generally include disposing a primary layer and secondary layer atop a foundation adapted to uniformly distribute the weight of the solar tracking assembly in the absence of additional securing or structural supports; moving a payload along a primary axis by operation of a first actuator controlling a primary layer; and moving the payload along a secondary axis by operation of a second actuator controlling a secondary layer.

One or more embodiments include the method of the preceding paragraph wherein a motor is electrically coupled to the first and second actuators to control movement of the primary and secondary layers.

### BRIEF DESCRIPTION OF DRAWINGS

FIG. 1 illustrates an isometric view of an embodiment of the solar tracking assembly with curved rack and pinion gears rotating a secondary layer about a secondary axis.

FIG. 2 illustrates a front elevation view of an embodiment of the solar tracking assembly with curved rack and pinion gears rotating a secondary layer about a secondary axis.

FIG. 3 illustrates an isometric view of another embodiment of the solar tracking assembly with a series of shafts with individual motors rotating a secondary layer about a secondary axis.

FIG. 4 illustrates a front elevation view of another embodiment of the solar tracking assembly with a series of shafts with individual motors rotating a secondary layer about a secondary axis.

FIG. 5 illustrates a partial isometric view of yet another embodiment of the solar tracking assembly with shafts and a bevel gear coupled to a perpendicular shaft with a central motor.

FIG. 6 illustrates a plan view of the solar tracking assembly with shafts and a bevel gear coupled to a perpendicular shaft with a central motor rotating a secondary layer about a secondary axis.

### DETAILED DESCRIPTION

### Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition skilled persons in the pertinent art have given that term as reflected in printed publications and issued patents at the time of filing. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable. Further, any ranges include iterative ranges of like magnitude falling within the expressly stated ranges or limitations.

The term “payload” should be understood by those of ordinary skill in the art to include any device that may benefit from tracking the Sun's movements. This can include but is not limited to solar panels, solar modules, solar collectors, photovoltaic panels, concentrator photovoltaic (CPV) modules, parabolic troughs, Fresnel reflectors, lenses, solar air heaters, solar hot water panels, solar towers, and the mirrors of a heliostat.

The term “size” should be understood by those of ordinary skill in the art to include the footprint of a foundation or layer.

The term “variations” should be understood by those of ordinary skill in the art to include the Sun's path or day arc. The Sun's path or day arc is the daily and seasonal arc-like path the Sun appears to follow across the sky as the Earth rotates and orbits the Sun.

The term “perpendicular shaft” should be understood by those of ordinary skill in the art to include a shaft that has a perpendicular relation to at least one shaft upon which the secondary layer is attached.

The term “axis” should be understood by those of ordinary skill in the art to include the imaginary line about which a layer rotates to track the north-south or east-west variations of the Sun.

Solar tracking assemblies and methods of tracking the movement of the sun are described herein. The solar tracking assemblies generally include a foundation, a primary layer, a secondary layer, and at least one motor.

The foundation generally includes a footing adapted to uniformly distribute the weight of the solar tracking assembly in the absence of additional securing or structural supports. The foundation can be customized for any installation surface and is optimal for a residential or commercial rooftop installation. In certain embodiments, the foundation can have a width of from about 5 feet to about 20 feet, or from about 8 feet to about 18 feet, or from about 12 feet to about 15 feet and a length from about 5 feet to about 12 feet, or from about 8 feet to about 18 feet, or from about 12 feet to about 15 feet. In one or more embodiments, the foundation has a ratio of width to length of about 1:3 to about 3:1, or about 1.5:3 to about 3:1.5. In one or more embodiments the foundation has a length that is greater than the width of the foundation. However, the foundation can also have a length that is greater than the width or a length that is equal to the width of the foundation.

The foundation can be the same size as the primary layer and/or the secondary layer. However, the foundation can also be of a different size than the primary layer and the same size as the secondary layer, of a different size than the primary layer and a different size than the secondary layer, or the same size as the primary layer and a different size than the secondary layer.

The foundation may be disposed atop a surface such as a commercial rooftop, residential rooftop, or the ground, for example. In one or more embodiments, the foundation does not require additional securing or structural supports for stability. However, additional securing or structural supports are not precluded from use with the foundation and certain surfaces may benefit from additional securing and structural supports to secure the assembly, such as a rooftop surface with a high angle of slant, dormers, slate, shading, east-west alignment, certain aesthetic considerations, or structural issues, for example.

The solar tracking assemblies may include a plurality of layers but is discussed in reference to a primary and secondary layer hereto. The secondary layer in one or more embodiments is adapted for receipt and attachment of at least one solar module. In such embodiments, the secondary layer is the layer of the solar tracking assembly most near the Sun. Thus, if the solar tracking assembly includes additional layers, the layer closest to the sun will be the layer adapted for attachment of the solar module. The number of solar modules will generally be dictated by the needs of the particular installation. However, the number of solar modules may range from 1 to 50, or from 2 to 20, or from 5 to 18, or from 10 to 15, or from 16 to 18, for example.

The primary layer is generally operably connected to the foundation and adapted to rotate relative to a primary axis. The primary layer may be connected to the foundation via a variety of methods. For example, the primary layer may be secured to the foundation by a pivoting element. The pivoting element may be a pivot, a fulcrum, a hinge, hydraulic jacks, or any other mechanism that allows the primary layer to move along an axis, for example. An independently movable pivoting element may provide additional tilt adjustments.

In one or more embodiments, the primary axis is adapted to track north-south variations of the sun. Alternatively, the primary axis may be adapted to track east-west variations of the sun.

The secondary layer is generally operably connected to the primary layer and adapted for attachment of a payload thereto. The secondary layer is further coupled to the primary layer to allow the secondary layer to rotate relative to a secondary axis.

In one or more embodiments, the secondary axis is adapted to track east-west variations of the sun. Alternatively, the secondary axis may be adapted to track north-south variations of the sun. In one or more embodiments, the secondary axis and the primary axis are adapted to track opposite variations of the sun.

The foundation, primary layer, and secondary layer can be made of a material such as aluminum, steel, stainless steel, carbon steel, an aluminum alloy, another metal or a non-metal, for example fiberglass, to fit the needs of a particular installation. It is not necessary that the foundation, primary layer, and secondary layers be of the same material. For example, the foundation could be made of a heavier material than one or any of the layers.

The motor is generally electrically coupled to a first and second actuator to control movement of the primary and secondary layers. The first and second actuators can be controlled through a variety of control systems, including but not limited to a logic control system, a hydraulic drive system, a pneumatic drive system, and programmable logic controller (PLC), for example, depending on the particular needs of an installation.

In one or more embodiments, the first actuator is at least one hydraulic jack that controls tilt adjustment along the primary axis. Alternatively, the first actuator could be substituted for another element that allows for a push-pull arrangement between the foundation and primary layer wherein the foundation layer remains stationary and the primary layer moves along a primary axis, such as a worm gear, rack and pinion gear, and non-hydraulic jacks, such as manual lift jacks, for example.

In one or more embodiments, the second actuator is a plurality of curved racks and pinion gears. The curved rack and pinion gears may be connected by at least one drive shaft electrically coupled to the motor. The motor may be synchronized through the use of electronic sensors and switches controlled by a control system, such as PLC, for example.

In one or more embodiments, the second actuator is at least one shaft with a bevel gear operably coupled to a perpendicular shaft. Alternatively, the at least one shaft may include another element coupled to a perpendicular shaft, such as a pinion gear, sprocket, spur gear, and worm gear, for example. The perpendicular shaft may be electrically coupled to a central motor controlling a hydraulic drive system. In the hydraulic drive system, rotational energy from a motor is transmitted to a second actuator through a series of connected shafts. The same hydraulic power units can be connected to power hydraulic jacks and motors. The hydraulic drive system may be synchronized through the use of electronic sensors and switches controlled by a control system, such as PLC, for example.

In one or more embodiments, the second actuator is a plurality of shafts adapted to control rotation along the secondary axis. The plurality of shafts may include individual motors. The individual motors of each shaft may be synchronized through the use of electronic sensors and switches in a hydraulic drive system controlled by a control system, such as programmable logic controller (PLC), for example.

The methods for tracking the Sun generally include moving a payload along the primary and secondary axis of the solar tracking assembly. Generally, a foundation layer will remain stationary while a primary layer rotates about a primary axis and a secondary layer rotates about a secondary axis to orient a payload attached to the secondary layer towards the Sun. The movement of the primary layer is controlled by operation of a first actuator and the movement of the secondary layer is controlled by operation of a second actuator. The first and second actuators can be controlled through a variety of control systems, including but not limited to a logic control system, a hydraulic drive system, a pneumatic drive system, and programmable logic controller (PLC), for example, depending on the particular needs of an installation.

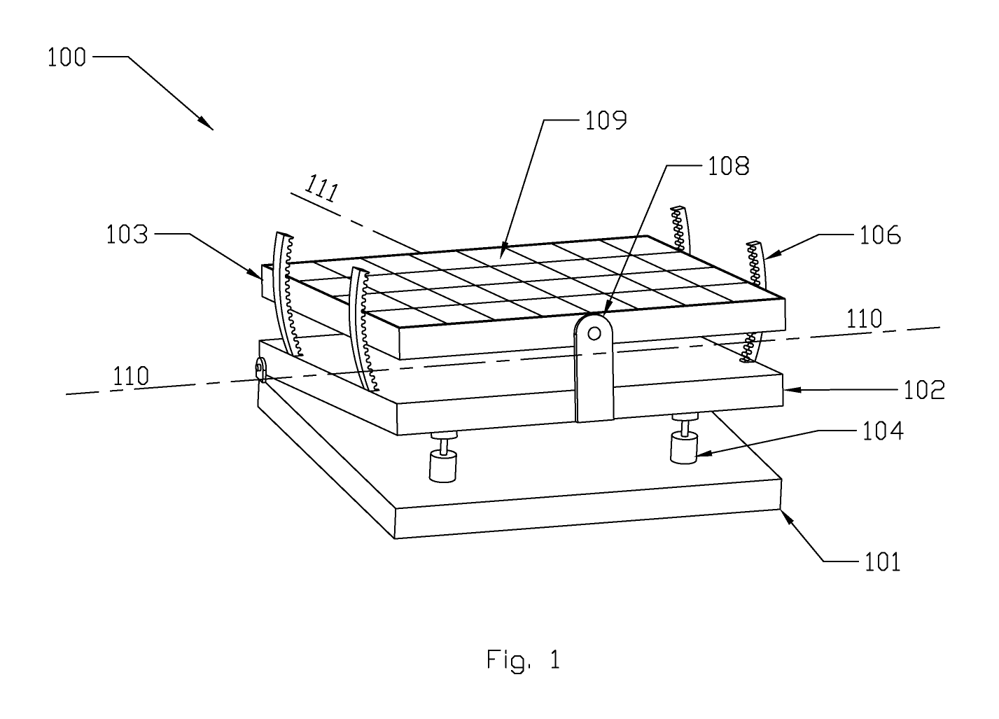

FIG. 1 illustrates an isometric view of an embodiment of the solar tracking assembly 100 with curved racks 106 and pinion gears 107 rotating a secondary layer 103 about a secondary axis 111. The solar tracking assembly 100 includes a foundation 101 in communication with a primary layer 102 that rotates about a primary axis 110 by the use of hydraulic jacks 104. The primary layer 102 is in communication with a secondary layer 103 that rotates about a secondary axis 111 by the use of curved racks 106 and pinion gears 107. A plurality of solar modules 109 are attached to the secondary layer 103 to collect solar energy.

The foundation 101 and primary layer 102 are secured to one another by a pivoting element 105. The primary layer 102 and secondary layer 103 are secured to one another by a plurality of curved racks 106. A motor 108 is disposed between the primary layer 102 and secondary layer 103.

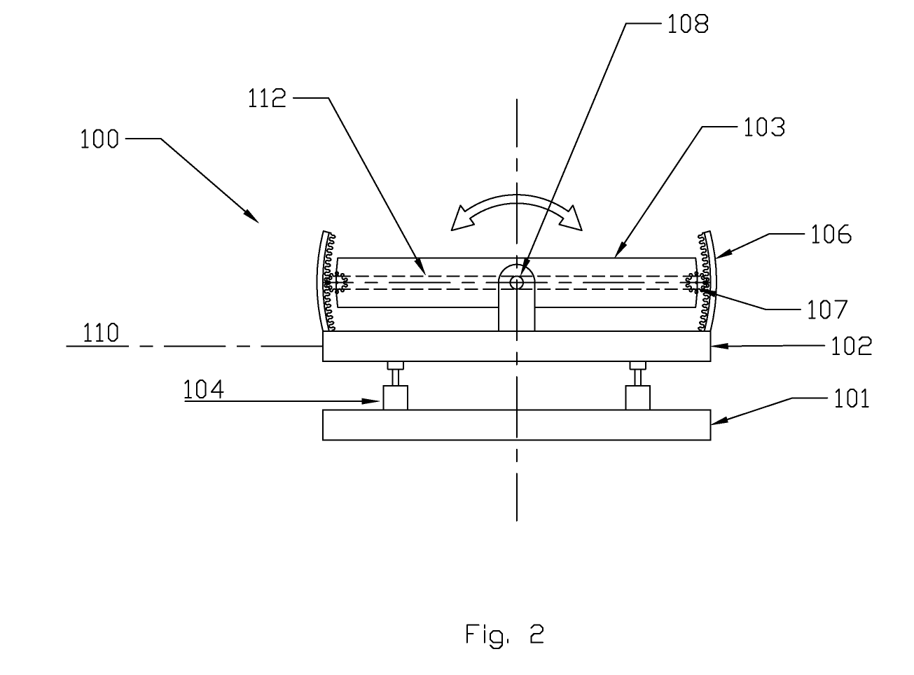

FIG. 2 illustrates a front elevation view of an embodiment of the solar tracking assembly 108 with curved racks 106 and pinion gears 107 rotating a secondary layer 103 about a secondary axis 111. Movement of the secondary layer 103 is accomplished through a central drive system wherein a motor 108 moves a drive shaft 112 that connects to pinion gears 107. The pinion gears 107 are adapted to move along their corresponding curved rack 106 to allow the secondary layer 103 to rotate along a secondary axis 111.

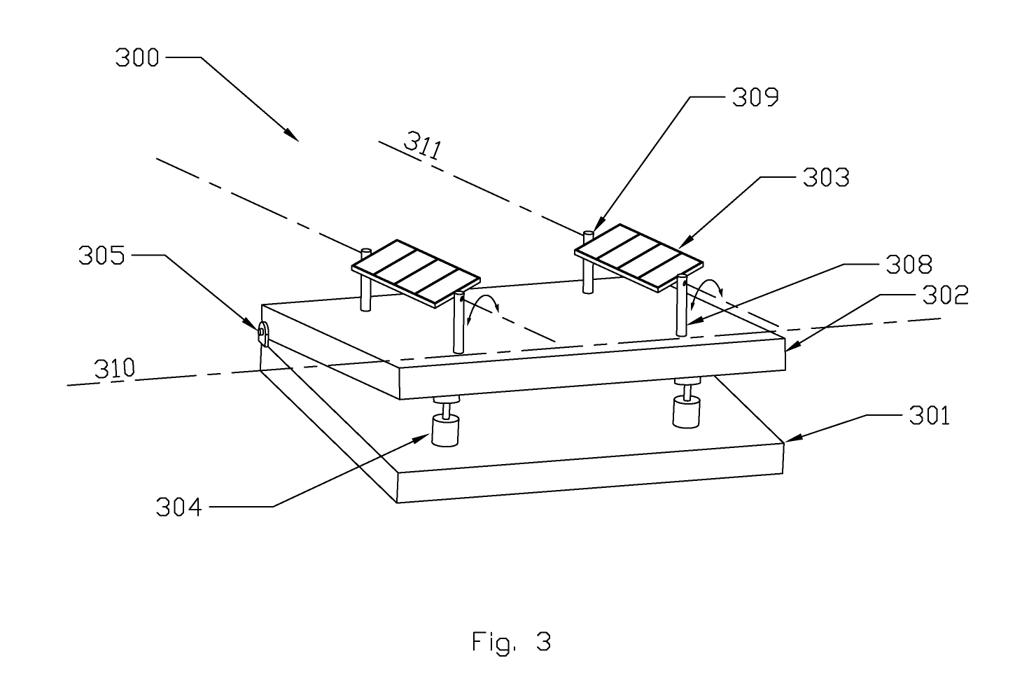

FIG. 3 illustrates an isometric view of another embodiment of the solar tracking assembly 300 with a series of shafts 306 with individual motors 308 rotating a secondary layer 303 about a secondary axis 311. The solar tracking assembly 300 includes a foundation 301 in communication with a primary layer 302 that rotates about a primary axis 310 by the operation of hydraulic jacks 304. The primary layer 302 is in communication with a secondary layer 303 that rotates about a secondary axis 311 by the use of a series of shafts 306 and individual motors 308. The individual motors 308 are disposed at each shaft 306 to control the movement of the secondary layer 303. A plurality of solar modules 309 are attached to the secondary layer 303.

The foundation 301 and primary layer 302 are secured to one another by a pivoting element 305.

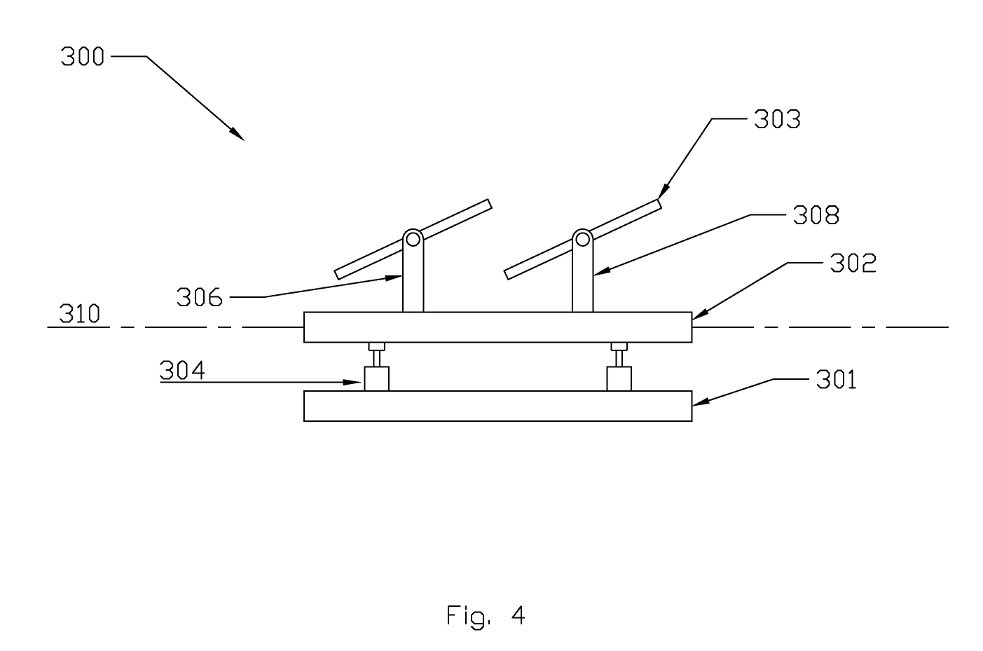

FIG. 4 illustrates a front elevation view of another embodiment of the solar tracking assembly 300 with a series of shafts 306 with individual motors 308 rotating a secondary layer 303 about a secondary axis 311.

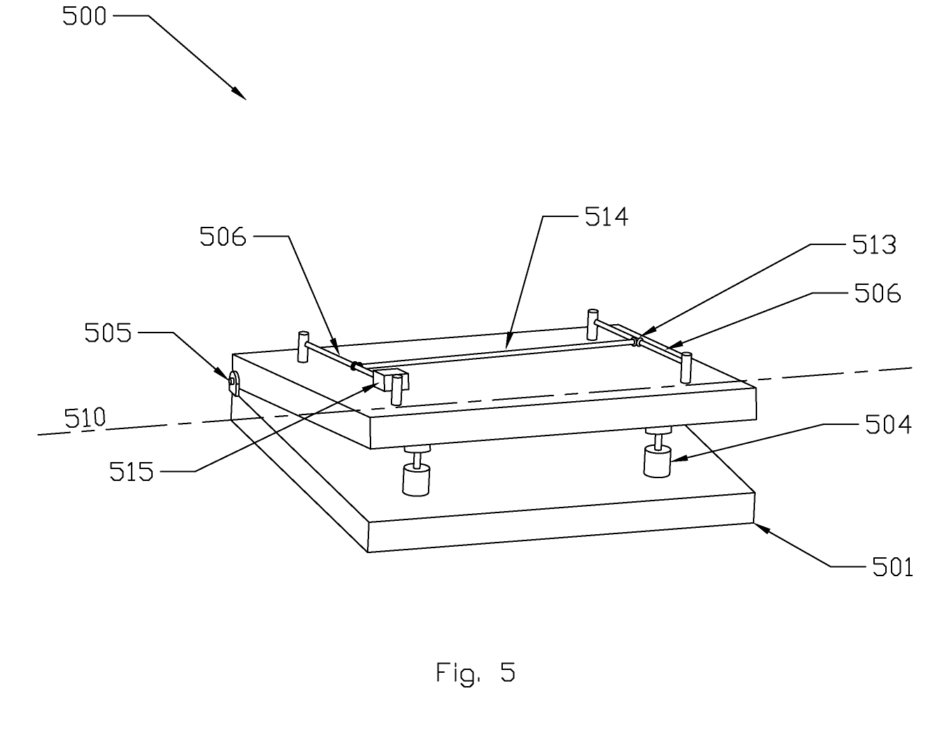

FIG. 5 illustrates a partial isometric view of yet another embodiment of the solar tracking assembly 500 with shafts 506 and a bevel gear 513 coupled to a perpendicular shaft 514 with a central motor 515. The solar tracking assembly 500 includes a foundation 501 in communication with a primary layer 502 that rotates about a primary axis 510 by the operation of hydraulic jacks 504. The foundation 501 and primary layer 502 are attached to one another by a pivoting element 505.

The partial view of FIG. 5 has the secondary layer 616 removed to demonstrate the secondary layer 616 rotates about a secondary axis 611 by operation the shafts 506 and bevel gears 513 that connect to a perpendicular shaft 514. There is a central motor 515 disposed along a shaft 506 and electrically coupled to the perpendicular shaft 514 to control movement of a secondary layer 616.

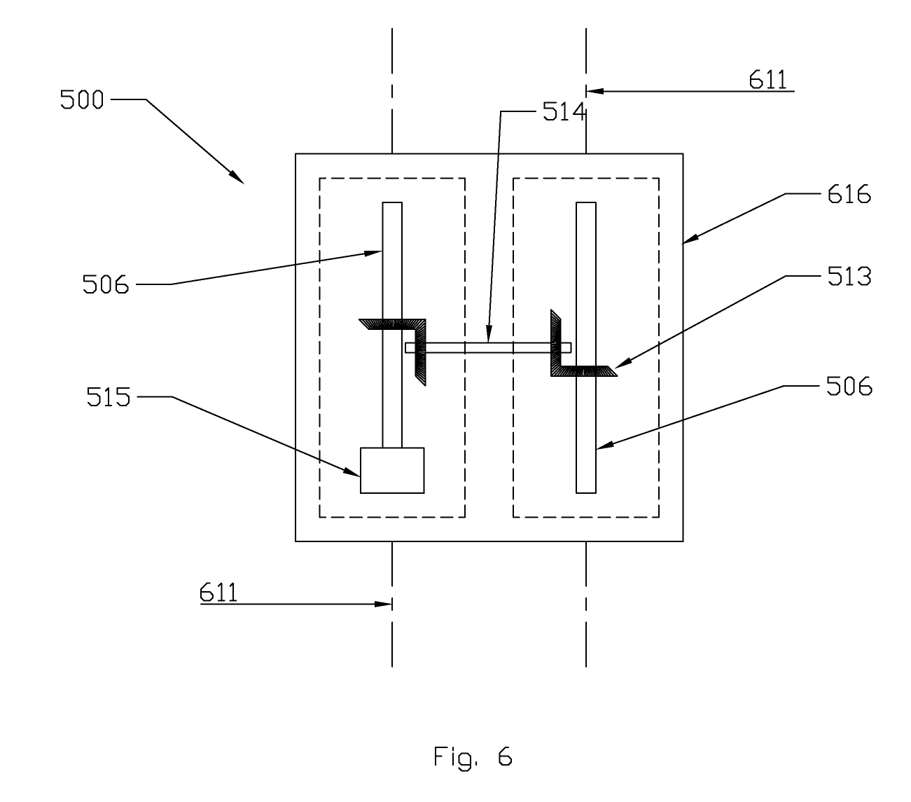

FIG. 6 illustrates a plan view of the solar tracking assembly 500 with shafts 506 and bevel gears 513 coupled to a perpendicular shaft 514 with a central motor 515 rotating a secondary layer 616 about a secondary axis 611. The secondary layer 616 is in communication with a shaft 506 that rotates a secondary layer 616 about a secondary axis 611.

While the foregoing is directed to embodiments of the present invention, other and further embodiments of the invention may be devised without departing from the basic scope thereof and the scope thereof is determined by the claims that follow.

What is claimed is:

1. A solar tracking assembly comprising:
a foundation comprising a footing adapted to uniformly distribute the weight of the solar tracking, assembly in the absence of additional securing or structural supports;
a primary layer being operably connected to the foundation, wherein the primary layer is adapted to rotate relative to a primary axis;
a secondary layer operably connected to the primary layer and adapted for attachment of a payload thereto and coupled to the primary layer to allow the secondary layer to rotate relative to a secondary axis; and
at least one motor electrically coupled to a first and second actuator to control movement of the primary and secondary layers.

2. The solar tracking assembly of claim 1 wherein the primary axis is adapted to track north-south variations of the sun and the secondary axis is adapted to track east-west variations of the sun.

3. The solar tracking assembly of claim 1 wherein the primary axis is adapted to track east-west variations of the sun and the secondary axis is adapted to track north-west variations of the sun.

4. The solar tracking assembly of claim 1 wherein the first actuator is at least one hydraulic jack that controls tilt adjustment along the primary axis.

5. The solar tracking assembly of claim 4 wherein the second actuator is a plurality of curved rack and pinion gears.

6. The solar tracking assembly of claim 5 wherein the plurality of curved rack and pinion gears are connected by at least one drive shaft electrically coupled to the motor.

7. The solar tracking assembly of claim 4 wherein the second actuator is at least one shaft adapted to control rotation along the secondary axis.

8. The solar tracking assembly of claim 7 wherein the at least one shaft has a bevel gear operably coupled to a perpendicular shaft.

9. The solar tracking assembly of claim 8 wherein the perpendicular shaft is electrically coupled to the motor.

10. The solar tracking assembly of claim 1 further comprising at least one solar module attached to the secondary layer.

11. The solar tracking assembly of claim 10 further comprising from 16 to 18 solar modules.

13. A method for tracking the sun comprising:
disposing a primary layer and secondary layer atop a foundation adapted to uniformly distribute the weight of the solar tracking assembly in the absence of additional securing, or structural supports;
moving a payload along a primary axis by operation of a first actuator controlling a primary layer; and
moving the payload along a secondary axis by operation of a second actuator controlling a secondary layer.

14. The method of claim 13 wherein a motor is electrically coupled to the first and second actuators to control movement of the primary and secondary layers.
